(19) United States
(12) Patent Application Publication
(10) Pub. No.: US 2004/0042371 A1
(43) Pub. Date: Mar. 4, 2004

(54) Optical disc drive

(75) Inventor: Tae-Seok Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/438,203

(22) Filed: May 15, 2003

(30) Foreign Application Priority Data
Sep. 3, 2002 (KR) 2002-52932

(51) Int. Cl. G11B 33/02

(52) U.S. Cl. 369/75.2

(57) ABSTRACT

An optical disc drive including a disc tray, a housing, an air guiding wall. The disc tray is accessibly mounted in the optical disc drive, including a disc driving unit to rotate a disc at a predetermined speed, an optical pick-up device to record and play data on/from the disc by a laser beam, a disc accommodating portion where the disc is put, and a tray wall constituting side walls of the disc accommodating portion. The housing includes a receiving unit to receive the disc tray and a tray extension unit that is extended from the receiving unit to constitute an extension surface of the disc accommodating portion. The air guiding wall is formed between a groove, which is formed between the receiving unit and the tray extension unit inside the housing, and a receiving unit, the air guiding wall preventing an air flow caused by the rotation of the disc from escaping from the disc drive through the groove, thereby guiding the air flow into the tray extension unit. Therefore, noise and vibration, which occur when the air flow escapes from the disc drive at a high speed, can be minimized by capping the groove formed in the disc drive.

### CROSS-REFERENCE TO RELATED APPLICATIONS

This application claims the benefit of Korean Application No. 2002-52932, filed Sep. 3, 2002, in the Korean Intellectual Property Office, the disclosure of which is incorporated herein by reference.

### BACKGROUND OF THE INVENTION

1. Field of the Invention

The present invention relates to an optical disc drive, and more particularly, to an optical disc drive preventing an air flow from escaping out of the optical disc drive, thereby reducing noises and vibrations occurring when an optical disc rotates in the optical disc drive.

2. Description of the Related Art

A conventional optical disc drive for a notebook computer, as shown in FIG. 1, has a structure satisfying the compatibility requirements of the notebook computer manufacturing industry. Therefore, the optical disc drive manufactured to be supplied to manufacturers of notebook computers cannot be modified at random. The optical disc drive used with the notebook computer includes a disc tray 10, which is accessibly mounted in the optical disc drive, and a housing 20, in which the disc tray 10 is received.

The housing 20 includes a receiving unit 21, in which the disc tray 10 is received, and a tray extension unit 22, which is extended from the receiving unit 21 to support an optical disc. Inside the housing 20, there exists a small groove 23 between the receiving unit 21 and the tray extension unit 22, which is formed in the manufacturing of the disc drive and causes noise and vibration when the optical disc rotates. FIG. 2 is an enlarged view of the groove 23 due to which an air flow escapes from the disc drive.

FIG. 3 illustrates an air flow occurring when the optical disc rotates in the optical disc drive of FIG. 1. The air flow within the optical disc drive is in the same direction as the rotation direction of the optical disc, and thus the air flow rotates at a high speed within an enclosed space of the disc drive, and then escapes quickly from the disc drive through the groove 23. As such, noise and vibration due to the unstable air flow occur in the disc drive.

In order to correctly read or write the data from or to a recording track of the disc, a beam, which is emitted from an optical device, is required to be correctly received on or from the recording track of the disc. Further, the angle between the recording track of the disc and the light axis of the beam emitted from the optical device is required to be constant. However, vibration due to the rotation of the disc cause degradations of recording and playing of the disc drive.

In particular, the disc rotates faster than usual in a sequential test for testing a data transmission rate and thus noise and vibration due to the air flow escaping through the groove 23 become even greater.

### SUMMARY OF THE INVENTION

It is an aspect of the present invention to provide a structure preventing an air flow from escaping from an optical disc drive at a high speed through a groove in a housing of the optical disc drive, thereby minimizing noise and vibration of the optical disc drive.

Additional aspects and advantages of the invention will be set forth in part in the description which follows and, in part, will be obvious from the description, or may be learned by practice of the invention.

According to an embodiment of the present invention, there is provided an optical disc drive comprising a disc tray, accessibly mounted in the optical disc drive, including a disc driving unit to rotate a disc at a predetermined speed, an optical pick-up device to record and play data on/from the disc by a laser beam, a disc accommodating portion where the disc is put, and a tray wall constituting side walls of the disc accommodating portion, a housing including a receiving unit to receive the disc tray and a tray extension unit that is extended from the receiving unit to constitute an extension surface of the disc accommodating portion and an air guiding wall formed between a groove, which is formed between the receiving unit and the tray extension unit inside the housing, and a receiving unit, the air guiding wall preventing an air flow caused by the rotation of the disc from escaping from the disc drive through the groove, thereby guiding the air flow into the tray extension unit.

Here, the air guiding wall is formed at an end inside the tray wall.

Accordingly, it is possible to minimize noise and vibration caused by the air flow which leaks from the optical disc drive at a high speed through the groove, by capping the groove exposed in a normal disc drive.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a perspective view of an optical disc drive used with a conventional notebook computer;

FIG. 2 is an enlarged view of a groove through which an air flow escapes from the optical disc drive shown in FIG. 1;

FIG. 3 illustrates an air flow occurring when the optical disc rotates in the optical disc drive of FIG. 1;

FIG. 4 is a perspective view of an optical disc drive in which an air guiding wall is formed according to an embodiment of the present invention;

FIG. 5 is a perspective view of an optical disc drive in which an air guiding wall is formed according to another embodiment of the present invention; and

FIG. 6 illustrates an air flow occurring when a disc rotates in the optical disc drive according to the present invention.

### DESCRIPTION OF THE PREFERRED EMBODIMENTS

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

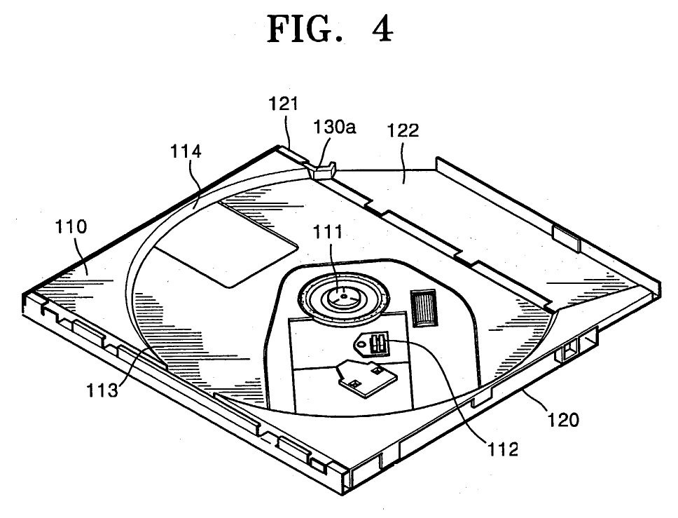

FIG. 4 is a perspective view of an optical disc drive in which an air guiding wall is formed according to an embodiment of the present invention.

Referring to FIG. 4, the optical disc drive satisfying the compatibility requirements of the notebook computer manufacturing industry includes a disc tray 110, a housing 120, and an air guiding wall 130a.

The disc tray 110 includes a disc driving unit 111, an optical pick-up device 112, a disc accommodating portion 113, and a tray wall 114.

The disc driving unit 111 includes a turntable on which an optical disc is put and a spindle motor which rotationally drives the turntable, and thus rotates the optical disc with a predetermined speed.

The optical pick-up device 112 writes or reads data to or from a sector of the optical disc by a laser beam.

The disc accommodating portion 113, in which the disc is put, isolates an air flow of a high speed caused by the rotation of the optical disc according to the spindle motor (not shown) so as to reduce noise.

The tray wall 114 includes a sidewall of the disc accommodating portion 113 and covers a side of the optical disc and guides the air flow caused by the rotation of the optical disc to rotate within the disc drive.

The housing 120 includes a receiving unit 121, in which the disc tray 110 is received, and a tray extension unit 122, which is extended from the receiving unit 121 to support the optical disc.

The receiving unit 121 receives the disc tray 110 having a rail pair (not shown) so that the disc tray 110 can slide into or out from the receiving unit 121.

The tray extension unit 122 corresponds to an extended surface of the disc accommodating portion 113. The disc loaded onto the disc tray 110 is supported by the disc accommodating portion 113 and the tray extension unit 122. Therefore, the air flow caused by the rotation of the optical disc rotates in a bottom surface formed by the disc accommodating portion 113 and the tray extension unit 122.

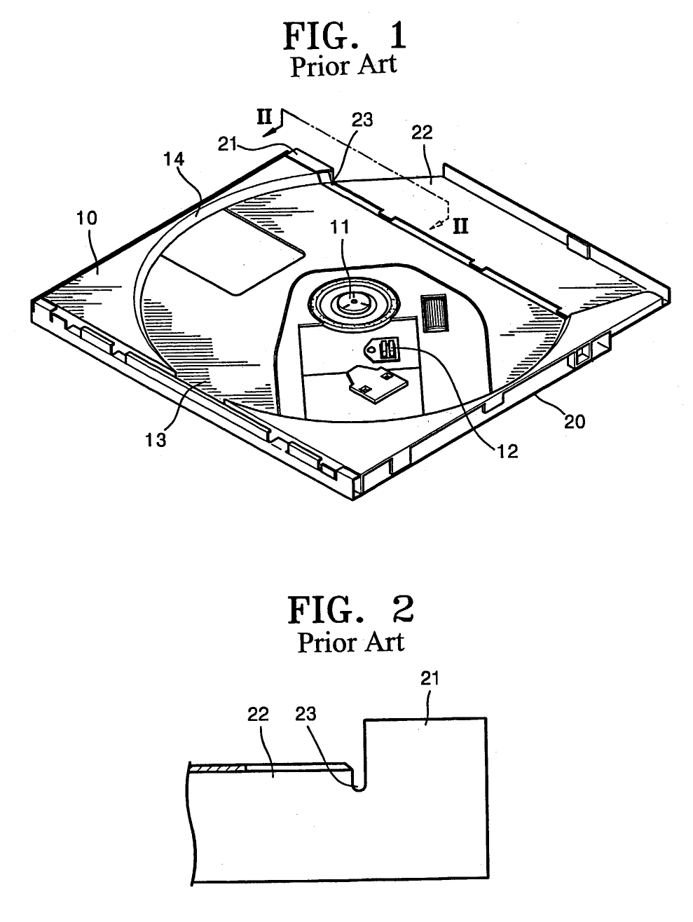

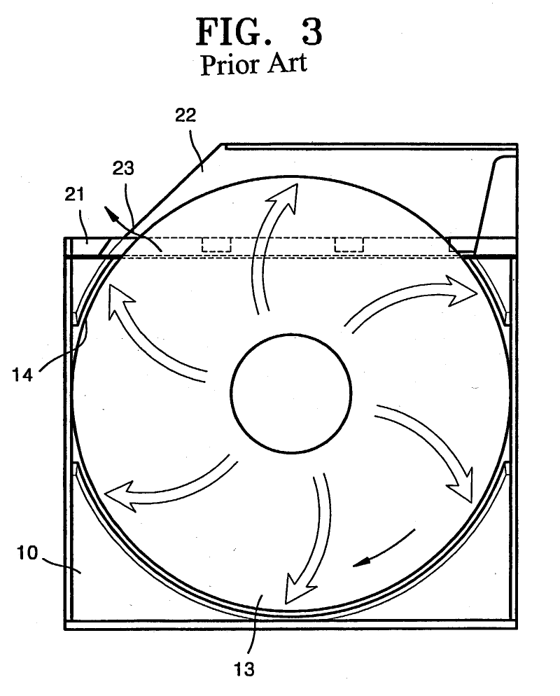

Inside the housing 120, a groove (not shown) is formed in the manufacturing of the disc drive between the receiving unit 121 and the tray extension unit 122, which causes noise and vibration. The position and shape of the groove (not shown) are the same as the position and shape of the groove 23 shown in FIGS. 1 through 3.

The air guiding wall 130a guides the air flow to rotate within the disc drive, thereby preventing the air flow from escaping out of the disc drive at a high speed through the groove 123.

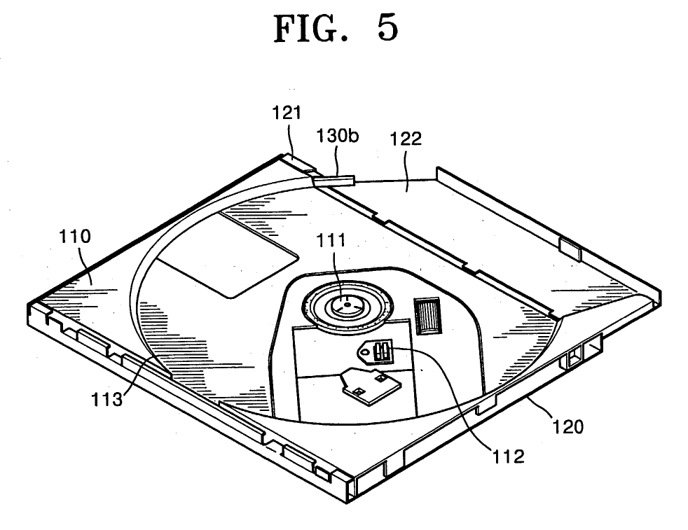

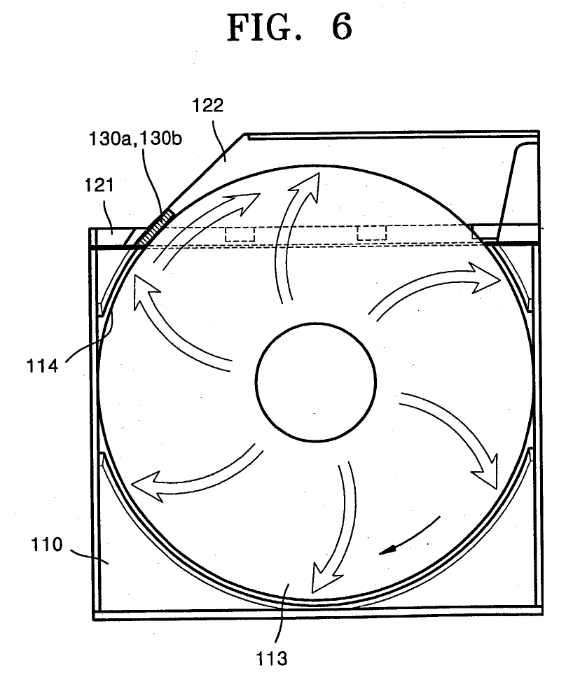

FIG. 5 is a perspective view of an optical disc drive in which an air guiding wall is formed according to another embodiment of the present invention.

The air guiding wall 130b of FIG. 5 is longer than the air guiding wall 130a of FIG. 3. The shapes of the air guiding walls 130a and 130b can be modified.

FIG. 6 illustrates an air flow occurring when the disc rotates on the optical disc drive according to the embodiments of FIGS. 4 and 5.

If the air guiding wall 130a or 130b is not formed in the optical disc drive, the air flow caused by the rotation of the optical disc in the disc accommodating portion 113 rotates along the tray wall 114 outside the tray and escapes from the disc drive at a high speed through the groove 123 in the housing 120, thereby causing noise and vibration. The air guiding wall 130a or 130b guides the air flow so as to lead it to flow into the tray extension unit 114.

As described above, the optical disc drive according to the embodiments of the present invention minimizes noise and vibration which occur when the air flow escapes from the disc drive at a high speed, by capping the groove formed in the disc drive. According to one embodiment of the present invention, the noise is reduced by 1˜2 dB.

It should be understood that although the preferred embodiments of the present invention relate to a disc drive for a notebook computer, the aspects of the present invention could also be advantageously used with other devices for recording and playing an optical disc.

While this invention has been particularly shown and described with reference to preferred embodiments thereof, it will be understood by those skilled in the art that various changes in form and details may be made therein without departing from the spirit and scope of the invention as defined by the appended claims and equivalents.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical disc drive comprising:
a disc tray, accessibly mounted in the optical disc drive, including a disc driving unit to rotate a disc at a predetermined speed, an optical pick-up device to record and play data on/from the disc by a laser beam, a disc accommodating portion where the disc is placed, and a tray wall constituting side walls of the disc accommodating portion;
a housing including a receiving unit to receive the disc tray and a tray extension unit that extends from the receiving unit to constitute an extension surface of the disc accommodating portion; and
an air guiding wall formed between a groove, which is formed between the receiving unit and the tray extension unit inside the housing, and a receiving unit, the air guiding wall preventing an air flow caused by a rotation of the disc from escaping from the disc drive through the groove, thereby guiding the air flow into the tray extension unit.

2. The optical disc drive of claim 1, wherein the air guiding wall is formed at an end of the tray wall.

3. An optical disc drive comprising:
a disc tray mounted in the optical disc drive and including:
a disc driving unit to rotate a disc at a predetermined speed, an optical pick-up device to record or read data on or from the disc by a laser beam,
a disc accommodating portion to receive the disc, and
a tray wall constituting side walls of the disc accommodating portion;
a housing including:
a receiving unit to receive the disc tray, and
a tray extension unit extending from the receiving unit to provide an extension surface of the disc accommodating portion; and
an air guiding wall to prevent an air flow caused by the rotation of the disc from escaping from the disc drive by guiding the air flow into the tray extension unit.

4. An optical disc drive comprising:
a disc tray mounted in the optical disc drive and including:
a disc driving unit to rotate a disc,
an optical pick-up device to record or read data on or from the disc, and
a disc accommodating portion to receive the disc;
a tray extension unit extending from the disc tray to provide an extension surface of the disc accommodating portion; and
an air guiding wall to prevent an air flow caused by the rotation of the disc from escaping from the disc drive by guiding the air flow from the disc accommodating portion to the tray extension unit.

5. The optical disk drive according to claim 4, wherein the air guide wall is designed to reduce noise by between 1 and 2 dB.
